(19) United States
(12) Patent Application Publication
(10) Pub. No.: US 2026/0237082 A1
(43) Pub. Date: Aug. 13, 2026

(54) DETERMINATION METHOD, PROCESSING DEVICE, PROCESSING SYSTEM, AND STORAGE MEDIUM

(71) Applicant: Kabushiki Kaisha Toshiba, Kawasaki-shi (JP)

(72) Inventors: Hiroki Shinagawa, Yokohama Kanagawa (JP); Yoshiyuki Hirahara, Mishima Shizuoka (JP); Masamitsu Fukuda, Yokohama Kanagawa (JP)

(21) Appl. No.: 19/442,857

(22) Filed: Jan. 7, 2026

(30) Foreign Application Priority Data
Feb. 7, 2025 (JP) 2025-019354

(51) Int. Cl. G06T 7/246; G01L 5/24; G06T 7/73

(52) U.S. Cl. CPC G06T 7/248; G01L 5/24; G06T 7/74; G06T 2207/30196; G06T 2207/30204

(57) ABSTRACT

There are provided a determination method, a processing device, a processing system, a program, and a storage medium that can check the operation of an MR device. A determination method according to an embodiment causes a computer to acquire a first image of a torque checker when a force is applied to the torque checker by a tool held by a hand. The computer is caused to perform hand tracking on the first image. The computer is caused to perform a first determination of determining whether or not the hand is detected by the hand tracking.

### CROSS-REFERENCE TO RELATED APPLICATIONS

This application is based upon and claims the benefit of priority from Japanese Patent Application No. 2025-019354, filed on Feb. 7, 2025; the entire contents of which are incorporated herein by reference.

### FIELD

Embodiments of the invention relate generally to a determination method, a processing device, a processing system, and a storage medium.

### BACKGROUND

Mixed reality devices (MR devices) are conventionally used to support tasks in manufacturing sites. Technology that can check the operation of an MR device is desirable.

### BRIEF DESCRIPTION OF THE DRAWINGS

FIG. 1 is a schematic view showing a processing system according to an embodiment;

FIG. 2 is a schematic view showing a communication flow of the processing system according to the embodiment;

FIG. 3 is a flowchart illustrating a determination method according to the embodiment;

FIG. 4 is a flowchart illustrating a second determination of the determination method according to the embodiment;

FIG. 5 is a flowchart illustrating a third determination of the determination method according to the embodiment;

FIG. 6 is a flowchart illustrating a fourth determination of the determination method according to the embodiment;

FIG. 7 is a schematic view illustrating a mixed reality device according to the embodiment;

FIG. 8 is a schematic view for describing the embodiment;

FIG. 9 is a schematic view showing a display example of the mixed reality device according to the embodiment;

FIGS. 10A and 10B are schematic views showing display examples of the mixed reality device according to the embodiment;

FIG. 11 is a schematic view showing a specific example of a virtual object displayed by the mixed reality device according to the embodiment;

FIG. 12 is a schematic view showing a tool being checked;

FIG. 13 is a drawing for describing a method for calculating a point of action;

FIG. 14 is a drawing for describing a method for calculating a point of action;

FIG. 15 is a drawing for describing a method for calculating a point of action;

FIG. 16 is a schematic view showing a display example of the mixed reality device according to the embodiment;

FIG. 17A is a table illustrating master data used in a determination, and FIG. 17B is a table illustrating check results;

FIG. 18 is a flowchart showing the flow of a checking task;

FIG. 19 is a schematic view illustrating an article that is a task object;

FIG. 20 is a schematic view for describing a display example of the processing system according to the embodiment;

FIG. 21 is a schematic view for describing a display example of the processing system according to the embodiment;

FIG. 22 is a schematic view for describing a display example of the processing system according to the embodiment; and

FIG. 23 is a schematic view illustrating a hardware configuration.

### DETAILED DESCRIPTION

A determination method according to an embodiment causes a computer to acquire a first image of a torque checker when a force is applied to the torque checker by a tool held by a hand. The computer is caused to perform hand tracking on the first image. The computer is caused to perform a first determination of determining whether or not the hand is detected by the hand tracking.

Embodiments of the invention will now be described with reference to the drawings. The drawings are schematic or conceptual; and the relationships between the thicknesses and widths of portions, the proportions of sizes between portions, etc., are not necessarily the same as the actual values thereof. The dimensions and/or the proportions may be illustrated differently between the drawings, even in the case where the same portion is illustrated. In the drawings and the specification of the application, components similar to those described thereinabove are marked with like reference numerals, and a detailed description is omitted as appropriate.

When an MR device is used during a task, the MR device displays information related to the task, virtual objects indicating the task location, etc. A worker can efficiently perform the task by referring to such information. The MR device also is utilized to determine the progress of the task, record the task, etc.

An MR device typically includes a camera. When a hand of a worker is imaged by the camera, the MR device detects the hand in the image and determines the coordinates of the hand. This function is called hand tracking. For example, the MR device displays virtual objects indicating task locations during the task. When a hand contacts a virtual object, the MR device determines that a task associated with the virtual object is being performed. Also, based on the determination result, it can be recorded that the associated task has been performed.

To realize such functions, hand tracking must be correctly performed by the MR device. For example, it is difficult to determine the progress or record the task if the hand tracking is not operating or the hand tracking processing is abnormal.

Embodiments of the invention can be used to check whether or not hand tracking is being performed correctly. Embodiments of the invention are applicable to devices (e.g., MR devices) configured to perform hand tracking. In addition to MR functions, embodiments of the invention are applicable to devices including augmented reality (AR) functions or virtual reality (VR) functions. Herein, a device that includes at least an MR function is referred to as an “MR device”.

### System Configuration

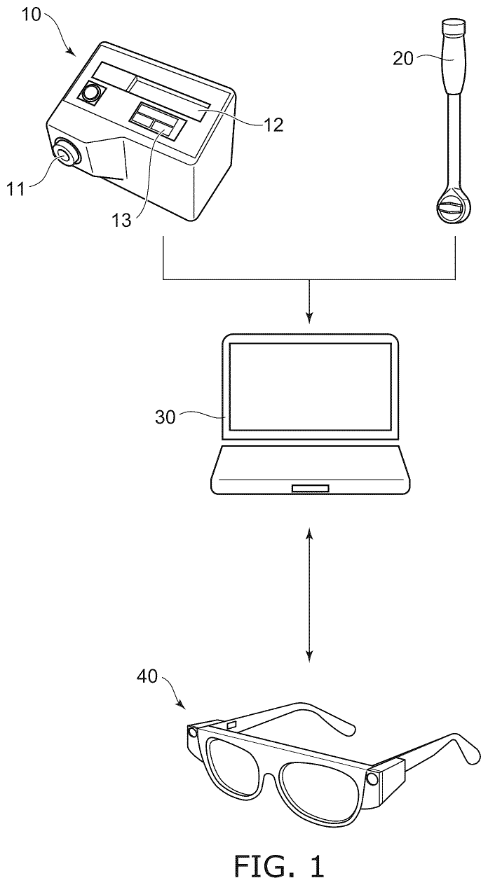

FIG. 1 is a schematic view showing a processing system according to an embodiment.

As shown in FIG. 1, the processing system 1 according to the embodiment includes a torque checker 10, a tool 20, a processing device 30, and an MR device 40.

The torque checker 10 is a device for measuring and calibrating the accuracy of the tool 20. For example, as shown in FIG. 1, the torque checker 10 includes an input part 11, a display part 12, and an operation part 13. A torque is applied to the input part 11 by the tool 20. The display part 12 displays the torque that is measured. The operation part 13 includes multiple switches for operating the torque checker 10.

The tool 20 is, for example, a wrench or a screw driver. The tool 20 includes a mechanism for tightening a fastener (a bolt or a nut) with a specified torque. By this mechanism, the tool 20 no longer applies torque to the fastener when the torque applied to the fastener by the tool 20 reaches a specified value. It is desirable for the difference to be small between the specified value and the torque actually applied to the fastener by the tool 20. The torque checker 10 is used to check whether or not a torque of the specified value is output by the tool 20.

The processing device 30 can communicate with the torque checker 10. The torque checker 10 transmits data toward the processing device 30. For example, the torque checker 10 transmits the measured torque, the measurement time, the measurement count, etc., to the processing device 30.

The tool 20 may be a digital tool that can detect torque. For example, the tool 20 is a digital torque wrench or a digital torque driver. In such a case, the tool 20 can communicate with the processing device 30. The tool 20 includes a sensor that measures the torque. The tool 20 transmits the measured torque to the processing device 30. The tool 20 also may be configured to transmit the torque measurement time, the measurement count, a determination result indicating that the measured torque reached the specified value, etc.

The processing device 30 can communicate with the MR device 40. The worker wears the MR device 40 during the task. The MR device 40 displays information related to the task to the worker. The processing device 30 transmits data necessary for the processing of the MR device 40 to the processing device 30 as appropriate. The MR device 40 also transmits the information obtained in the task to the processing device 30.

For example, the torque checker 10 is used before performing the task with the tool 20. The worker uses the torque checker 10 to check whether or not the torque applied by the tool 20 is normal. The embodiment of the invention can be used to check whether or not the operation of the MR device 40 is normal simultaneously when checking the tool 20 with the torque checker 10.

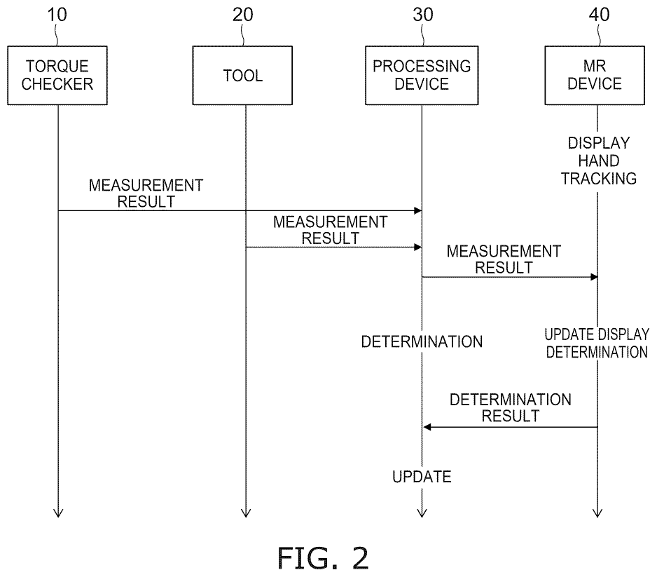

FIG. 2 is a schematic view showing a communication flow of the processing system according to the embodiment.

When the check of the tool 20 is started, the MR device 40 displays a virtual space overlaid on a real space. Information and virtual objects are displayed in the virtual space. For example, a virtual object is displayed at the position at which the hand of the worker is to be located when checking the tool 20.

The MR device 40 also includes a camera and images the task. The MR device 40 detects hands of the worker by performing hand tracking on the obtained image. For example, the MR device 40 determines whether or not a hand has contacted a virtual object based on the result of the hand tracking. 30

The worker that wears the MR device 40 fits the tool 20 onto the input part 11 of the torque checker 10 and applies a torque to the input part 11. The torque checker 10 measures the torque applied to the input part 11 and transmits the measurement result (a first measurement result) to the processing device 30. The measurement result includes the measurement value of the torque, the measurement time, and the measurement count.

At this time, the MR device 40 may measure, based on the result of the hand tracking, the coordinates of the location at which the tool 20 is acting on the input part 11. Hereinafter, the point at which the tool 20 fits onto the input part 11 and applies a force to the input part 11 is referred to as the “point of action”.

When the tool 20 is a digital tool, the tool 20, in addition to the torque checker 10, can measure the applied torque. In such a case, the tool 20 transmits the measurement result (a second measurement result) to the processing device 30. The measurement result includes the measurement value of the torque, the measurement time, and the measurement count.

When the measurement result is received from the torque checker 10 or the tool 20, the processing device 30 transmits the measurement result to the MR device 40. The processing device 30 also determines whether or not the tool 20 is normal based on the measurement result.

When the measurement result is received, the MR device 40 updates the displayed information based on the measurement result. The MR device 40 also determines whether or not the hand tracking is operating correctly. The MR device 40 transmits the determination result to the processing device 30. When the hand tracking is operating correctly, the data obtained based on the hand tracking also may be transmitted to the processing device 30.

When the data is received from the MR device 40, the processing device 30 updates a database related to the task based on the data. For example, the error between the measurement value of the torque and the specified value of the torque, the pass/fail determination result, the determination result related to the operation of the hand tracking, etc., are registered in the database.

Specific examples of methods for determining whether or not the hand tracking is operating correctly will now be described. The determination method according to the embodiment includes at least a first determination. The first determination includes determining whether or not a hand is detected by the hand tracking.

### Determination Method

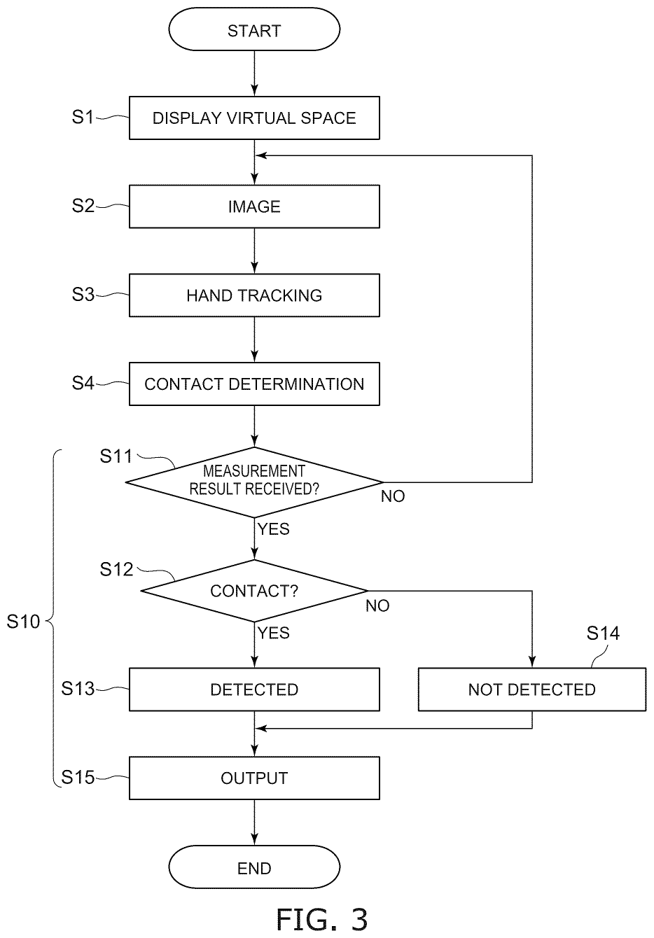

FIG. 3 is a flowchart illustrating the determination method according to the embodiment.

When the MR device 40 has been activated and the coordinate system has been set, the MR device 40 displays a virtual space overlaid on a real space (step S1). Information and a virtual object are displayed in the virtual space. The virtual object is displayed at the position at which the hand of the worker is to be located when checking the tool 20 with the torque checker 10. The coordinates at which the virtual object is displayed are preregistered.

The MR device 40 also images frontward of the camera included in the MR device 40 (step S2). The MR device 40 performs hand tracking on the acquired image (step S3). When the hand of the worker is visible in the image, the hand is detected by the hand tracking, and the coordinates of the hand are measured.

Here, “performing hand tracking” refers to the MR device 40 attempting to operate the program of the hand tracking. Accordingly, even when the MR device 40 performs the processing of step S2, the hand tracking function may not actually be realized. For example, if there is a discrepancy in the software or hardware of the MR device 40, the program of the hand tracking may not actually operate even when the MR device 40 tries to execute the program. If the hand tracking function is not realized, the hand is not detected, even though the hand may be visible in the image.

The MR device 40 determines whether or not the hand contacts the virtual object (step S4). For example, the MR device 40 calculates the distance between the coordinates of the hand and the coordinates of the virtual object. When the distance is less than a preset threshold, the MR device 40 determines that the hand has contacted the virtual object.

When the distance is not less than the threshold or the coordinates of the hand are not obtained, the hand is determined not to have contacted the virtual object.

After the hand tracking, the MR device 40 performs the first determination (step S10). In the first determination, first, the MR device 40 determines whether or not a measurement result from the torque checker 10 or the tool 20 is received (step S11). When a measurement result is not received, step S2 is re-performed.

When the measurement result is received, the MR device 40 determines whether or not the hand has contacted the virtual object up to that point in time (step S12). For example, the determination results of step S4 being performed one or more times from the start of the check until step S12 is performed are referenced. When a determination result indicating contact of the hand with the virtual object is obtained in any step S4, the MR device 40 determines that the hand has contacted the virtual object up to that point in time. When no determination result indicating contact of the hand with the virtual object is obtained in any step S4, the MR device 40 determines that the hand has not contacted the virtual object up to that point in time.

When the determination result in step S12 is “YES”, the MR device 40 determines that the hand is detected by the hand tracking (step S13). When the determination result in step S12 is “NO”, the MR device 40 determines that the hand is not detected by the hand tracking (step S14).

A measurement result being obtained from the torque checker 10 or the tool 20 indicates that the worker is applying a torque to the torque checker 10 with the tool 20. As described above, the virtual object is displayed at the position at which the hand of the worker is to be located when checking the tool 20. Therefore, when the hand tracking is operating correctly, the hand is determined to contact the virtual object before the MR device 40 receives the measurement result. When the hand is determined not to have contacted the virtual object even though the MR device 40 has received the measurement result, this means that the hand is not detected by the hand tracking.

The MR device 40 may output the determination result related to the hand tracking (step S15). For example, when it is determined that the hand is detected, the MR device 40 outputs that the hand is detected, contact of the hand with the virtual object is detected, etc. When it is determined that the hand is not detected, it is output that the hand is not detected, contact of the hand with the virtual object is not detected, etc. The output may be performed by a display or a voice.

According to the first determination, it can be checked whether or not the hand is detected by the hand tracking simultaneously with the worker checking the tool 20 with the torque checker 10.

### Second Determination

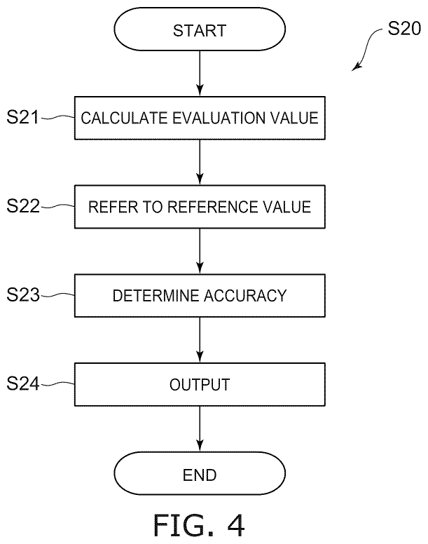

FIG. 4 is a flowchart illustrating a second determination of the determination method according to the embodiment.

The second determination shown in FIG. 4 (step S20) may be performed in addition to the first determination shown in FIG. 3. The second determination is performed to check the accuracy of the hand tracking. The second determination is performed after the first determination.

First, the MR device 40 calculates an evaluation value (step S21). The evaluation value is a value for evaluating the accuracy of the hand tracking, and is calculated using the coordinates of the hand measured by the hand tracking.

The MR device 40 then refers to a reference value corresponding to the evaluation value (step S22). The reference value is preregistered according to the evaluation value. The MR device 40 compares the evaluation value and the reference value and determines the accuracy of the hand tracking based on the comparison result (step S23). The MR device 40 may output the determination result of the accuracy (step S24).

As a first specific example, the MR device 40 calculates the coordinates of the point of action by using the coordinates of the hand. The MR device 40 calculates the distance between the coordinates of the hand and the coordinates of the point of action as the evaluation value. The distance between the coordinates of the hand and the coordinates of the point of action corresponds to the length of the tool 20 (the distance between the head and the grip). In such a case, the length of the tool 20 to be checked is preregistered as the reference value. The MR device 40 determines whether or not the difference between the evaluation value and the reference value is less than a preset threshold. The MR device 40 may calculate the ratio of the difference to the reference value and determine whether or not the ratio is less than a preset threshold. When the difference or the ratio is less than the threshold, the MR device 40 determines that the coordinates of the hand are accurately measured by the hand tracking.

As a second specific example, when the coordinates of the input part 11 are preregistered, the distance between the coordinates of the hand and the coordinates of the input part 11 may be calculated as the evaluation value. When the torque checker 10 is being used, the distance between the coordinates of the hand and the coordinates of the input part 11 corresponds to the length of the tool 20. The length of the tool 20 to be checked is preregistered as the reference value. The MR device 40 determines whether or not the difference between the evaluation value and the reference value or the ratio of the difference to the reference value is less than the preset threshold.

As a third specific example, when the coordinates of the input part 11 are preregistered, the distance between the coordinates of the point of action and the coordinates of the input part 11 may be calculated as the evaluation value. The distance between the coordinates of the point of action and the coordinates of the input part 11 corresponds to the length of the tool (e.g., the socket) for fitting the tool 20 onto the input part 11. In such a case, the length of the tool (e.g., the socket) is preregistered as the reference value. The MR device 40 determines whether or not the difference between the evaluation value and the reference value or the ratio of the difference to the reference value is less than the preset threshold. The reference value may be set to zero when the coordinates of the point of action and the coordinates of the input part 11 can be considered to be substantially the same. In such a case, the distance between the coordinates of the point of action and the coordinates of the input part 11 may be directly compared to the threshold.

By performing the second determination in addition to the first determination, it can be checked whether or not the accuracy of the hand tracking is sufficient in addition to checking whether or not the hand tracking is operating.

### Third Determination

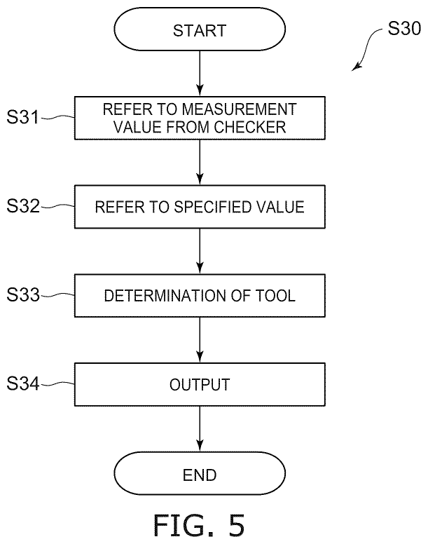

FIG. 5 is a flowchart illustrating a third determination of the determination method according to the embodiment.

The processing device 30 performs the third determination (step S30) shown in FIG. 5 after the measurement result of the torque checker 10 is received. The third determination determines whether or not the tool 20 is normal.

First, the processing device 30 refers to the torque measured by the torque checker 10 (step S31). The processing device 30 refers to the specified value of the torque applied by the tool 20 (step S32). The processing device 30 compares the measurement value and the specified value and determines whether or not the tool 20 is normal based on the comparison result (step S33).

For example, the processing device 30 determines whether or not the difference between the measurement value and the specified value is less than a preset threshold. The processing device 30 may determine whether or not the ratio of the difference to the specified value is less than a preset threshold. When the difference or the ratio is less than the threshold, the processing device 30 determines that the tool 20 is normal. When the tool 20 is normal, the tool 20 can be used to apply the specified torque to the fastener.

When the tool 20 is a digital tool, the processing device 30 may use the measurement value from the tool 20 instead of the specified value. For example, the processing device 30 determines whether or not the difference between the measurement value from the torque checker 10 and the measurement value from the tool 20 is less than a preset threshold. The processing device 30 may determine whether or not the ratio of the difference to the measurement value from the torque checker 10 is less than a preset threshold. When the difference or the ratio is less than the threshold, the processing device 30 determines that the tool 20 is normal.

The processing device 30 may output the determination result of step S33 (step S34). For example, when the difference or the ratio is less than the threshold, the processing device 30 outputs that the result of the check passed. When the difference or the ratio is not less than the threshold, the processing device 30 outputs that the result of the check failed.

### Fourth Determination

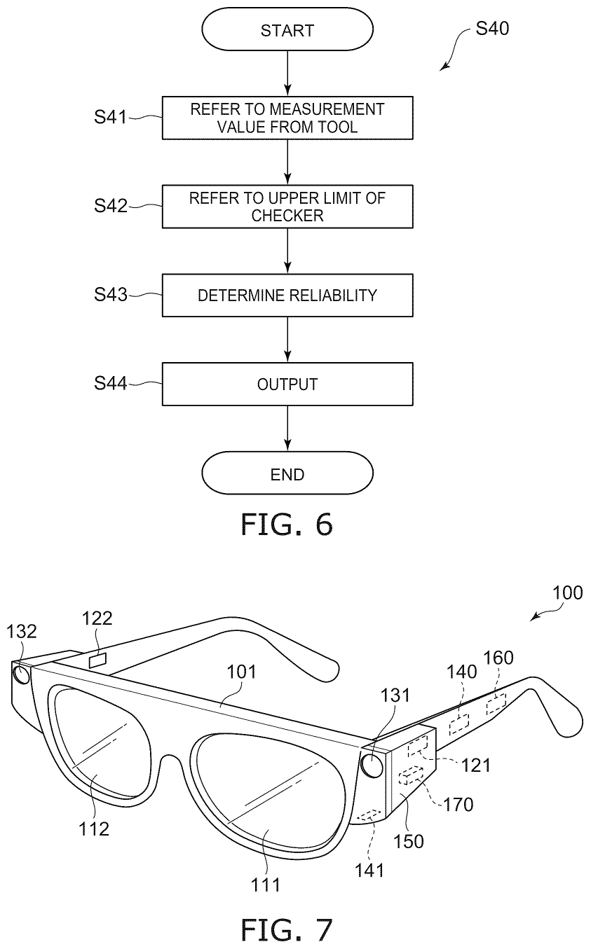

FIG. 6 is a flowchart illustrating a fourth determination of the determination method according to the embodiment.

When the tool 20 is a digital tool, the fourth determination (step S40) shown in FIG. 6 also may be performed. The fourth determination determines the reliability of the determination result of the third determination.

The processing device 30 refers to the torque measured by the tool 20 (step S41). The processing device 30 refers to the upper limit of the torque that can be measured by the torque checker 10 (step S42). The processing device 30 compares the measurement value and the upper limit and determines the reliability of the result of the third determination based on the comparison result (step S43).

For example, the processing device 30 determines whether or not the measurement value is not more than the upper limit. When the measurement value is greater than the upper limit, the processing device calculates the difference between the measurement value and the upper limit. When the measurement value is not more than the upper limit, or when the measurement value is greater than the upper limit and the difference is less than a preset threshold, the result of the third determination is determined to be reliable. When the measurement value is greater than the upper limit and the difference is not less than the threshold, the result of the third determination is determined not to be reliable. Instead of the difference, the ratio of the difference to the upper limit may be compared to a preset threshold.

There is an upper limit to the highest torque measurable by the torque checker 10. When the torque that is applied is greater than the upper limit, the difference increases between the torque actually applied by the tool 20 and the torque measured by the torque checker 10. In such a case, it cannot be determined whether or not the tool 20 is normal by using the measurement value from the torque checker 10. Therefore, the result of the third determination is determined not to be reliable.

The processing device 30 may output the determination result of step S43 (step S44). For example, when it is determined that the result of the third determination is not reliable, the processing device 30 outputs an instruction to the worker to perform the checking task again. When the result of the third determination is determined to be reliable, the processing device 30 may not output anything, or may output that the checking task is appropriate.

The torque checker 10 may be configured to perform the third determination. In such a case, the specified value of the torque applied by the tool 20 is registered in the torque checker 10. The torque checker 10 compares the measurement value of the torque and the specified value and determines whether or not the tool 20 is normal based on the comparison result. The torque checker 10 transmits the determination result to the processing device 30. The processing device 30 may output the determination result.

The processing device 30 may be able to switch between a first mode in which the first determination and the second determination can be performed, and a second mode in which the first determination and the second determination are not performed. In the first mode, the processing device 30 performs the various determinations based on the measurement result of the torque checker 10 or the tool 20. In the second mode, the processing device 30 does not perform either the first determination or the second determination, even when the processing device 30 receives the measurement result from the torque checker 10 or the tool 20. For example, initially, the worker may confirm how to use the torque checker 10 or the tool 20. When confirming, the processing device 30 is set to the second mode; and determinations are not performed. As a result, needless determinations can be avoided. For example, the worker can use an input device such as a mouse, a microphone (audio input), etc., to input the selection of the first and second modes to the processing device 30.

Advantages of the embodiment will now be described.

As described above, MR devices are used to support tasks in manufacturing sites. The MR devices must operate correctly to efficiently or accurately support the tasks. According to the embodiment, at least the first determination is performed to check the operation of the MR device 40. In the first determination, hand tracking is performed on an image of a hand holding the tool 20; and it is determined whether or not the hand is detected by the hand tracking. The first determination also is performed when a force is applied to the torque checker 10 with the tool 20. In other words, whether or not the hand is detected by the hand tracking of the MR device 40 also can be checked simultaneously with checking the tool 20 with the torque checker 10. According to the embodiment, the tool 20 and the MR device 40 can be efficiently checked before the task.

It is favorable also to perform the second determination after performing the first determination. Even when the hand tracking is operating, it may be difficult to accurately support the task if the accuracy is low. Also, there is a possibility that an erroneous record may be generated when generating the task record based on the result of the hand tracking. By checking the accuracy of the hand tracking in the second determination, the task can be more accurately supported. Also, a more accurate task record can be generated.

Specific examples of the MR device according to the embodiment, processing that uses the MR device, etc., will now be described.

### MR Device

FIG. 7 is a schematic view illustrating the mixed reality device according to the embodiment.

For example, the MR device 100 shown in FIG. 7 is used as the processing device 30. The MR device 100 includes a frame 101, a lens 111, a lens 112, a projection device 121, a projection device 122, an image camera 131, a depth camera 132, a sensor 140, a microphone 141, a processing device 150, a battery 160, and a storage device 170.

In the illustrated example, the MR device 100 is a binocular head mounted display. Two lenses, i.e., the lens 111 and the lens 112, fit into the frame 101. The projection device 121 and the projection device 122 respectively project information onto the lenses 111 and 112.

The projection device 121 and the projection device 122 display the recognition result of a body of a worker, a virtual object, etc., onto the lenses 111 and 112. Only one of the projection device 121 or the projection device 122 may be included; and information may be displayed on only one of the lens 111 or the lens 112.

The lens 111 and the lens 112 are light-transmissive. The worker can visually recognize reality via the lenses 111 and 112. Also, the worker can visually recognize the information projected onto the lenses 111 and 112 by the projection devices 121 and 122. Information is displayed to overlap real space by being projected by the projection devices 121 and 122.

The image camera 131 detects visible light and obtains a two-dimensional image. The depth camera 132 irradiates infrared light and obtains a depth image based on the reflected infrared light. The sensor 140 is a six-axis detection sensor and is configured to detect angular velocities in three axes and accelerations in three axes. The microphone 141 accepts an audio input.

The processing device 150 controls components of the MR device 100. For example, the processing device 150 controls the display by the projection devices 121 and 122. The processing device 150 detects movement of the visual field based on a detection result of the sensor 140. The processing device 150 changes the display by the projection devices 121 and 122 according to the movement of the visual field. The processing device 150 also is configured to perform various processing by using data obtained from the image camera 131 and the depth camera 132, data of the storage device 170, etc.

The battery 160 supplies power necessary for the operations to the components of the MR device 100. The storage device 170 stores data necessary for the processing of the processing device 150, data obtained by the processing of the processing device 150, etc. The storage device 170 may be located outside the MR device 100, and may communicate with the processing device 150.

The MR device according to the embodiment is not limited to the illustrated example, and may be a monocular head mounted display. The MR device may be an eyeglasses-type as illustrated, or may be a helmet-type.

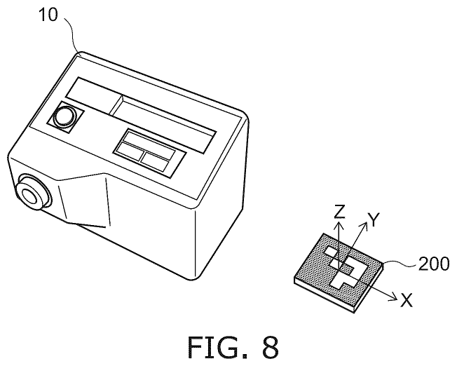

FIG. 8 is a schematic view for describing the embodiment.

For example, as shown in FIG. 8, a marker 200 is disposed beforehand proximate to the torque checker 10. When starting the fastening task, the image camera 131 and the depth camera 132 image the marker 200. The processing device 150 recognizes the marker 200 in an image that is imaged. The processing device 150 sets a three-dimensional coordinate system referenced to the position and orientation of the marker 200.

In the illustrated example, the marker 200 is an AR marker. Instead of the AR marker, a one-dimensional code (a barcode), a two-dimensional code (a QR code (registered trademark)), etc., may be used as the marker 200. Or, instead of a marker, the origin may be indicated by a hand gesture. The processing device 150 sets the three-dimensional coordinate system by using multiple points indicated by the hand gesture as a reference.

When the checking task is started, the image camera 131 and the depth camera 132 image the left hand or the right hand of the worker. The processing device 150 performs hand tracking on the acquired image. More specifically, the hand includes multiple joints such as DIP joints, PIP joints, MP joints, CM joints, etc. The processing device 150 detects the joints of the hand in the image, and uses the coordinates of any of the joints as the coordinates of the hand. The centroids of multiple joints may be used as the coordinates of the hand. Or, the center of the entire hand may be used as the coordinates of the hand. The processing device 150 may cause the projection device 121 and the projection device 122 to display the detection result of the hand on the lenses 111 and 112.

### Display Examples

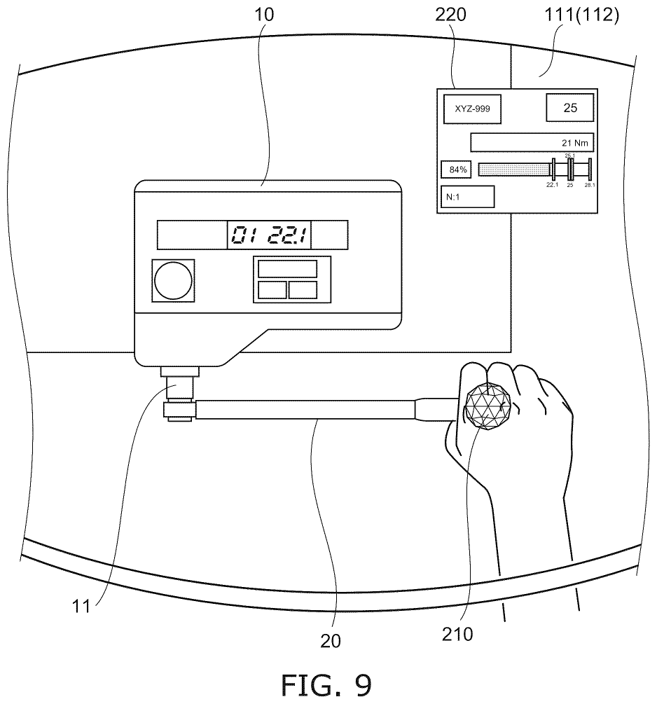

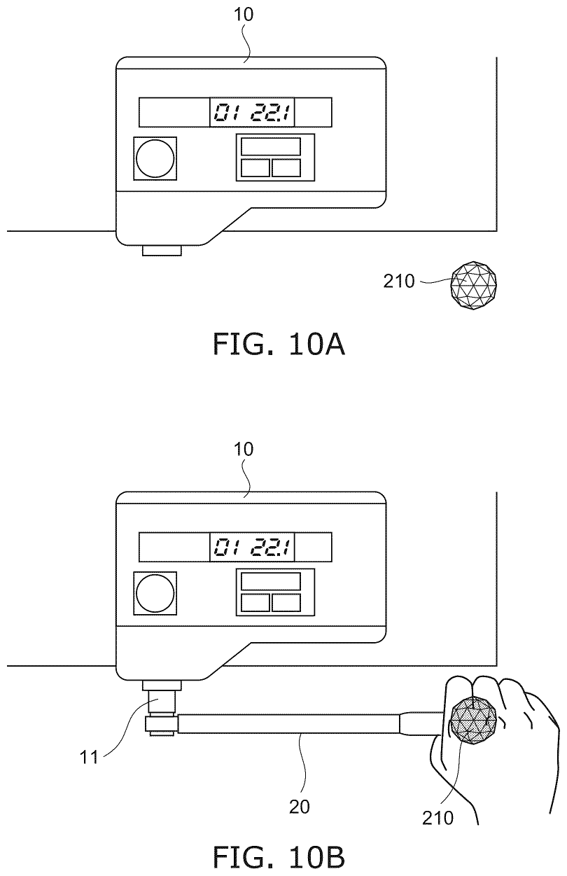

FIGS. 9, 10A, and 10B are schematic views showing display examples of the mixed reality device according to the embodiment.

For example, as shown in FIG. 9, the processing device 150 displays a virtual object 210. The virtual object 210 is displayed at the position at which the hand of the worker is to be located when the tool 20 applies a force to the input part 11. In the illustrated example, the virtual object 210 is a sphere. The shape, color, and the like of the virtual object can be set freely as long as the worker can visually recognize the virtual object as being different from real space.

The position at which the virtual object 210 is displayed is preregistered using a coordinate system based on the origin of the marker 200. The three-dimensional coordinate system used to register the display position of the virtual object 210 and the three-dimensional coordinate system set during the task are a common three-dimensional coordinate system. The positional relationship between the torque checker 10 and the marker 200 when preparing the virtual object is adjusted to be the same as the positional relationship between the torque checker 10 and the marker 200 when performing the task. As a result, the prepared virtual object can be displayed to be overlaid on real space at an appropriate position when performing the checking task.

When starting the checking task, the worker fits the tip of the tool 20 onto the input part 11 and holds the grip of the tool 20 with the hand. At this time, the hand of the worker contacts the virtual object 210. When the hand tracking operates correctly, the processing device 150 determines that the hand of the worker contacts the virtual object 210.

More specifically, the processing device 150 calculates the distance between the coordinates of the hand and the coordinates of the virtual object 210. When the distance is less than a preset threshold, the processing device 150 determines that the hand contacts the virtual object 210. As an example, the diameter of the virtual object 210 in FIG. 9 corresponds to the threshold. The sphere indicates the range in which the hand is determined to contact the virtual object 210.

When the hand is determined to contact the virtual object 210, the processing device 150 records the determination result. The worker applies a force to the torque checker 10 by turning the tool 20 with the hand contacting the virtual object 210. The processing device 150 receives the measurement result from the torque checker 10. In such a case, the measurement result is received, and contact between the hand and the virtual object is determined. Accordingly, in the first determination, it is determined that the hand can be detected by the hand tracking.

The processing device 150 may control the display of the virtual object 210 based on the determination of the contact between the hand and the virtual object 210. For example, the processing device 150 causes the display of the virtual object 210 when the hand is in contact to be different from the display of the virtual object 210 when the hand is not in contact. In the example shown in FIG. 10A, the hand does not contact the virtual object 210. In the example shown in FIG. 10B, the hand contacts the virtual object 210. The color of the virtual object 210 shown in FIG. 10B is different from the color of the virtual object 210 shown in FIG. 10A. The size, shape, or the like of the virtual object 210 may be changed instead of the color.

When the display of the virtual object 210 changes according to the contact between the hand and the virtual object 210, the worker can determine, based on the presence or absence of the change of the virtual object 210, whether or not the hand is detected by the hand tracking.

As shown in FIG. 9, the processing device 150 may display a virtual object 220 that includes information related to the task. For example, the virtual object 220 displays the torque measured by the torque checker 10 or the tool 20.

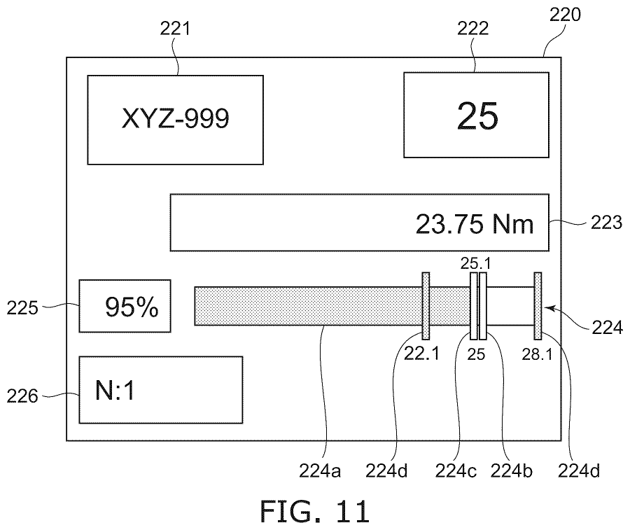

FIG. 11 is a schematic view showing a specific example of the virtual object displayed by the mixed reality device according to the embodiment.

Here, an example is described in which the tool 20 is a digital tool; and the processing device 30 can communicate with the tool 20. As shown in FIG. 11, the virtual object 220 includes task information including an identification number 221, a specified torque 222, a detected value 223, a meter 224, a ratio 225, and a count 226.

The identification number 221 is a unique identification number assigned to the tool 20. The specified torque 222 is a torque that is specified for the tool 20. The detected value 223 indicates the torque measured by the tool 20.

The meter 224 shows the specified value of the torque of the tool 20, the measurement result from the torque checker 10, and the measurement result from the tool 20. As one specific example, the meter 224 includes a bar 224a and graduations 224b to 224d. The bar 224a shows the measurement result of the torque from the tool 20. The graduation 224b shows the measurement result of the torque from the torque checker 10. The graduation 224c indicates the torque specified for the tool 20. The graduation 224d indicates the acceptable error of the specified value of the torque.

The ratio 225 is the ratio of the measurement value from the tool 20 with respect to the specified torque. The count 226 is the screw-tightening count. The worker uses the tool 20 to apply torque to the torque checker 10 while checking the information displayed in the virtual object 220.

The processing device 150 performs the second determination after the first determination is performed based on the result of the contact determination between the hand and the virtual object. In the second determination, an evaluation value is calculated based on the result of the hand tracking. Here, an example is described in which the distance between the coordinates of the hand and the coordinates of the point of action is used as the evaluation value.

### Calculation of Point of Action

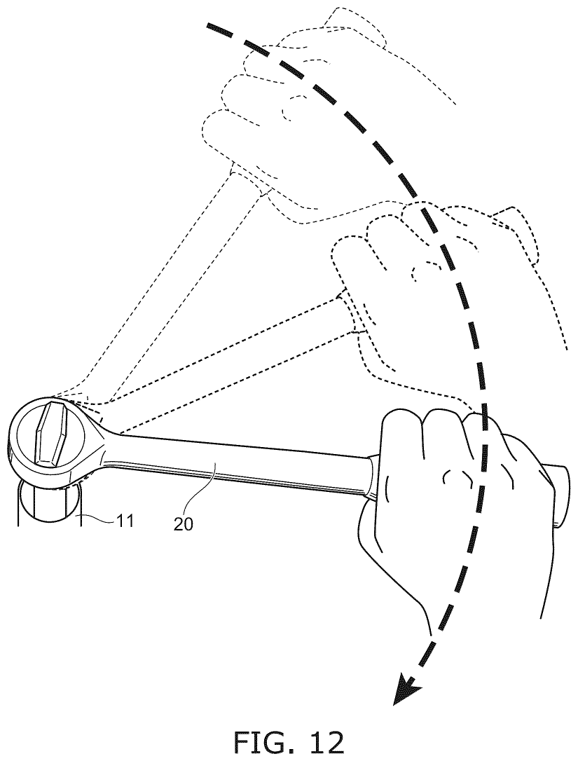

FIG. 12 is a schematic view showing the tool 20 being checked.

The worker applies a force to the tool 20 after fitting the tool 20 onto the input part 11. The processing device 150 repeatedly determines the coordinates of the hand while the worker moves the tool 20. When the tool 20 is a wrench, the hand is positioned on a circumference centered on the head of the tool 20 as shown in FIG. 12. The hand is moved to trace a circular arc. The processing device 150 utilizes the movement of the hand to calculate the point of action (the center coordinates of the rotation of the tool). One of the following first to third methods can be used to calculate the center coordinates.

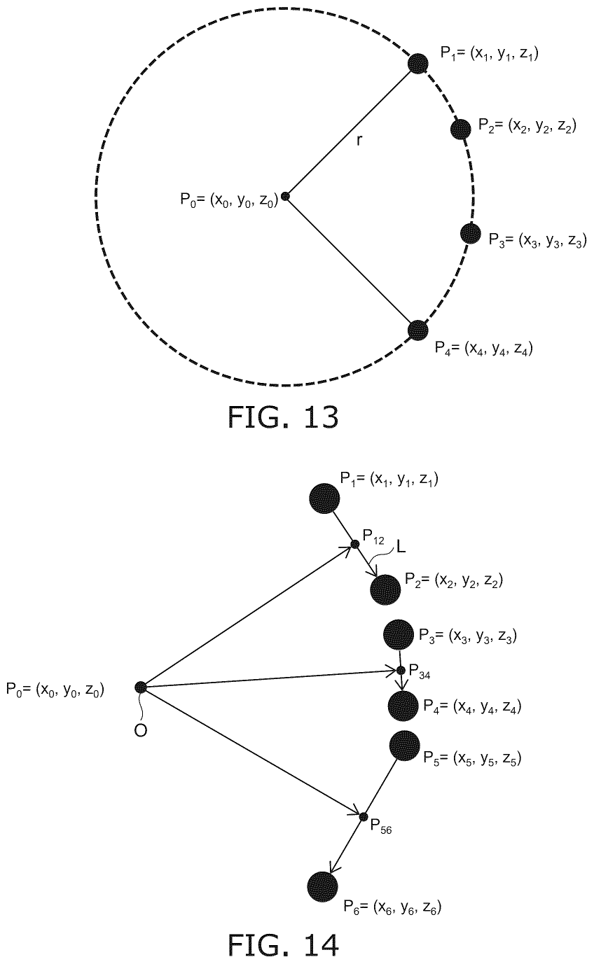

FIGS. 13 to 15 are drawings for describing methods for calculating the point of action.

In the first method, the processing device 150 extracts four mutually-different coordinate sets from the multiple coordinate sets that are measured. The processing device 150 calculates a sphere that passes through the four coordinate sets. The sphere is represented by the formula of a spherical surface. Here, as shown in FIG. 13, the four coordinate sets are taken as P₁(x₁, y₁, z₁), P₂(x₂, y₂, z₂), P₃(x₃, y₃, z₃), and P₄(x₄, y₄, z₄). The coordinate set of the center of the sphere is taken as P₀(x₀, y₀, z₀). The radius of the sphere is taken as r. r corresponds to the distance from the head of the tool 20 to the hand (the grip), and is preregistered. In such a case, the formula of a spherical surface is represented by the following Formula (1). In Formula (1), k, l, m, and n are constants.

$${( x - {x}_{0} )}^{2} + {( y - {y}_{0} )}^{2} + {( z - {z}_{0} )}^{2} = {r}^{2} . \qquad [ Formula 1 ]$$

The following Formula (2) is obtained by substituting the coordinate set P₁ in Formula (1). Formula (2) is rewritten as Formula (3).

$${( {x}_{1} - {x}_{0} )}^{2} + {( {y}_{1} - {y}_{0} )}^{2} + {( {z}_{1} - {z}_{0} )}^{2} = {r}^{2} \qquad [ Formula 2 ]$$

$$\begin{matrix}{x}_{0}^{2} + {y}_{0}^{2} + {z}_{0}^{2} - 2 {x}_{1} {x}_{0} - 2 {y}_{1} {y}_{0} - 2 {z}_{1} {z}_{0} + {x}_{1}^{2} + {y}_{1}^{2} + {z}_{1}^{2} = 0 & [ Formula 3 ]\end{matrix}$$

Similarly, the following Formulas (4) to (6) are obtained by substituting the coordinate sets P₂ to P₄ in Formula (1).

$${x}_{0}^{2} + {y}_{0}^{2} + {z}_{0}^{2} - 2 {x}_{2} {x}_{0} - 2 {y}_{2} {y}_{0} - 2 {z}_{2} {z}_{0} + {x}_{2}^{2} + {y}_{2}^{2} + {z}_{2}^{2} = 0 \qquad [ Formula 4 ]$$

$${x}_{0}^{2} + {y}_{0}^{2} + {z}_{0}^{2} - 2 {x}_{3} {x}_{0} - 2 {y}_{3} {y}_{0} - 2 {z}_{3} {z}_{0} + {x}_{3}^{2} + {y}_{3}^{2} + {z}_{3}^{2} = 0 \qquad [ Formula 5 ]$$

$${x}_{0}^{2} + {y}_{0}^{2} + {z}_{0}^{2} - 2 {x}_{4} {x}_{0} - 2 {y}_{4} {y}_{0} - 2 {z}_{4} {z}_{0} + {x}_{4}^{2} + {y}_{4}^{2} + {z}_{4}^{2} = 0 \qquad [ Formula 6 ]$$

The coordinate set P₀(x₀, y₀, z₀) is calculated by solving Formulas (3) to (6) as simultaneous equations. The center of a sphere passing through the four coordinate sets P₁(x₁, y₁, z₁), P₂(x₂, y₂, z₂), P₃(x₃, y₃, z₃), and P₄(x₄, y₄, z₄) is obtained thereby. The processing device 150 uses the coordinate set P₀(x₀, y₀, z₀) of the center of the sphere as the coordinates of the point of action of the tool 20.

The processing device 150 may extract multiple combinations of four coordinate sets. The processing device 150 calculates the coordinates of the center of the sphere for each combination. As a result, the coordinates of the center are calculated for each of the multiple spheres. An error is present in the measured coordinates of the hand. Therefore, the calculated coordinates of the multiple centers are different from each other. The processing device 150 uses the multiple coordinate sets to determine the coordinates to be used as the rotation center of the tool 20. For example, the processing device 150 calculates the median value of the multiple coordinate sets as the coordinates of the point of action of the tool 20. The processing device 150 may calculate the average value or mode of the multiple coordinate sets as the coordinates of the point of action of the tool 20. The accuracy of the calculated point of action can be increased thereby.

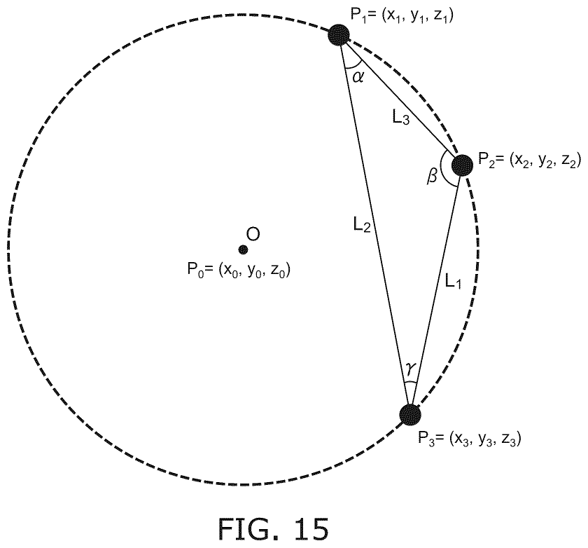

In the second method, the processing device 150 extracts three coordinate set pairs from the multiple coordinate sets that are measured. Each pair of coordinate sets is made of two coordinate sets. In the example shown in FIG. 14, the pair of coordinate sets P₁ and P₂, the pair of coordinate sets P₃ and P₄, and the pair of coordinate sets P₅ and P₆ are extracted. The six coordinate sets are taken as P₁(x₁, y₁, z₁), P₂(x₂, y₂, z₂), P₃(x₃, y₃, z₃), P₄(x₄, y₄, z₄), P₅ (x₅, y₅, z₅), and P₆ (x₆, y₆, z₆). The processing device 150 calculates the midpoint of the two coordinate sets for each pair. The coordinate sets of the midpoints of the pairs are taken as P₁₂, P₃₄, and P₅₆.

As described above, the hand moves in an arc-like shape. Accordingly, the perpendicular bisectors that pass through the midpoints of the coordinate set pairs pass through the center of the circle. The center of the circle is taken as the coordinate set P₀(x₀, y₀, z₀). In such a case, as shown in Formula (7), the inner product of the vector from the coordinate set P₁ to the coordinate set P₂ and the vector from the coordinate set P₁₂ to the coordinate set P₀ is zero. Formula (7) can be rewritten as Formula (8).

$$( {P}_{2} - {P}_{1} ) \cdot ( {P}_{0} - {P}_{12} ) = 0 \qquad [ Formula 7 ]$$

$$( {x}_{2} - {x}_{1} ) ( {x}_{0} - ( {x}_{1} + {x}_{2} ) / 2 ) + ( {y}_{2} - {y}_{1} ) ( {y}_{0} - ( {y}_{1} + {y}_{2} ) / 2 ) + ( {z}_{2} - {z}_{1} ) ( {z}_{0} - ( {z}_{1} + {z}_{2} ) / 2 ) = 0 \qquad [ Formula 8 ]$$

The following Formulas (9) and (10) are obtained similarly from the other coordinate set pairs.

$$( {x}_{4} - {x}_{3} ) ( {x}_{0} - ( {x}_{3} + {x}_{4} ) / 2 ) + ( {y}_{4} - {y}_{3} ) ( {y}_{0} - ( {y}_{3} + {y}_{4} ) / 2 ) + ( {z}_{4} - {z}_{3} ) ( {z}_{0} - ( {z}_{3} + {z}_{4} ) / 2 ) = 0 \qquad [ Formula 9 ]$$

$$( {x}_{6} - {x}_{5} ) ( {x}_{0} - ( {x}_{5} + {x}_{6} ) / 2 ) + ( {y}_{6} - {y}_{5} ) ( {y}_{0} - ( {y}_{5} + {y}_{6} ) / 2 ) + ( {z}_{6} - {z}_{5} ) ( {z}_{0} - ( {z}_{5} + {z}_{6} ) / 2 ) = 0 \qquad [ Formula 10 ]$$

The coordinate set P₀(x₀, y₀, z₀) is calculated by solving these simultaneous equations. The processing device 150 calculates the coordinate set P₀(x₀, y₀, z₀) as the coordinates of the point of action of the tool 20.

The processing device 150 may extract four or more coordinate set pairs. The processing device 150 selects three coordinate set pairs from the four or more coordinate set pairs and calculates the coordinate set P₀ for each combination of the selected coordinate set pairs. The processing device 150 calculates the median value, average value, or mode of the multiple coordinate sets P₀ as the coordinates of the point of action of the tool 20. As a result, the accuracy of the calculated point of action can be increased.

In the third method, the processing device 150 extracts three mutually-different coordinate sets from the multiple coordinate sets that are measured. The processing device 150 calculates a circumcenter O of the three coordinate sets. Here, as shown in FIG. 15, the three coordinate sets are taken as P₁(x₁, y₁, z₁), P₂(x₂, y₂, z₂), and P₃(x₃, y₃, z₃). The coordinate set of the circumcenter O is taken as P₀(x₀, y₀, z₀). The length of the side opposite to the coordinate set P₁ of a triangle obtained by connecting the coordinate sets P₁ to P₃ to each other is taken as L₁. The length of the side opposite to the coordinate set P₂ is taken as L₂. The length of the side opposite to the coordinate set P₃ is taken as L₃. The angle at the coordinate set P₁ is taken as α. The angle at the coordinate set P₂ is taken as β. The angle at the coordinate set P₃ is taken as γ. In such a case, the coordinates of the circumcenter O are represented by the following Formula (11). In Formula (11), the symbols marked with arrows represent position vectors. Formula (11) can be rewritten as Formula (12). Formula (12) can be decomposed into Formulas (13) to (15).

$$\vec{{P}_{0}} = \frac{{L}_{1}^{2} ( {L}_{2}^{2} + {L}_{3}^{2} - {L}_{1}^{2} ) \vec{{P}_{1}} + {L}_{2}^{2} ( {L}_{3}^{2} + {L}_{1}^{2} - {L}_{2}^{2} ) \vec{{P}_{2}} + {L}_{3}^{2} ( {L}_{1}^{2} + {L}_{2}^{2} - {L}_{3}^{2} ) \vec{{P}_{3}}}{{L}_{1}^{2} ( {L}_{2}^{2} + {L}_{3}^{2} - {L}_{1}^{2} ) + {L}_{2}^{2} ( {L}_{3}^{2} + {L}_{1}^{2} - {L}_{2}^{2} ) + {L}_{3}^{2} ( {L}_{1}^{2} + {L}_{2}^{2} - {L}_{3}^{2} )} \qquad [ Formula 11 ]$$

$$( {x}_{0} , {y}_{0} , {z}_{0} ) = \frac{{L}_{1}^{2} ( {L}_{2}^{2} + {L}_{3}^{2} - {L}_{1}^{2} ) ( {x}_{1} , {y}_{1} , {z}_{1} ) + {L}_{2}^{2} ( {L}_{3}^{2} + {L}_{1}^{2} - {L}_{2}^{2} ) ( {x}_{2} , {y}_{2} , {z}_{2} ) + {L}_{3}^{2} ( {L}_{1}^{2} + {L}_{2}^{2} - {L}_{3}^{2} ) ( {x}_{3} , {y}_{3} , {z}_{3} )}{{L}_{1}^{2} ( {L}_{2}^{2} + {L}_{3}^{2} - {L}_{1}^{2} ) + {L}_{2}^{2} ( {L}_{3}^{2} + {L}_{1}^{2} - {L}_{2}^{2} ) + {L}_{3}^{2} ( {L}_{1}^{2} + {L}_{2}^{2} - {L}_{3}^{2} )} \qquad [ Formula 12 ]$$

$${x}_{0} = \frac{{L}_{1}^{2} ( {L}_{2}^{2} + {L}_{3}^{2} - {L}_{1}^{2} ) {x}_{1} + {L}_{2}^{2} ( {L}_{3}^{2} + {L}_{1}^{2} - {L}_{2}^{2} ) {x}_{2} + {L}_{3}^{2} ( {L}_{1}^{2} + {L}_{2}^{2} - {L}_{3}^{2} ) {x}_{3}}{{L}_{1}^{2} ( {L}_{2}^{2} + {L}_{3}^{2} - {L}_{1}^{2} ) + {L}_{2}^{2} ( {L}_{3}^{2} + {L}_{1}^{2} - {L}_{2}^{2} ) + {L}_{3}^{2} ( {L}_{1}^{2} + {L}_{2}^{2} - {L}_{3}^{2} )} \qquad [ Formula 13 ]$$

$${y}_{0} = \frac{{L}_{1}^{2} ( {L}_{2}^{2} + {L}_{3}^{2} - {L}_{1}^{2} ) {y}_{1} + {L}_{2}^{2} ( {L}_{3}^{2} + {L}_{1}^{2} - {L}_{2}^{2} ) {y}_{2} + {L}_{3}^{2} ( {L}_{1}^{2} + {L}_{2}^{2} - {L}_{3}^{2} ) {y}_{3}}{{L}_{1}^{2} ( {L}_{2}^{2} + {L}_{3}^{2} - {L}_{1}^{2} ) + {L}_{2}^{2} ( {L}_{3}^{2} + {L}_{1}^{2} - {L}_{2}^{2} ) + {L}_{3}^{2} ( {L}_{1}^{2} + {L}_{2}^{2} - {L}_{3}^{2} )} \qquad [ Formula 14 ]$$

$${z}_{0} = \frac{{L}_{1}^{2} ( {L}_{2}^{2} + {L}_{3}^{2} - {L}_{1}^{2} ) {z}_{1} + {L}_{2}^{2} ( {L}_{3}^{2} + {L}_{1}^{2} - {L}_{2}^{2} ) {z}_{2} + {L}_{3}^{2} ( {L}_{1}^{2} + {L}_{2}^{2} - {L}_{3}^{2} ) {z}_{3}}{{L}_{1}^{2} ( {L}_{2}^{2} + {L}_{3}^{2} - {L}_{1}^{2} ) + {L}_{2}^{2} ( {L}_{3}^{2} + {L}_{1}^{2} - {L}_{2}^{2} ) + {L}_{3}^{2} ( {L}_{1}^{2} + {L}_{2}^{2} - {L}_{3}^{2} )} \qquad [ Formula 15 ]$$

x₀, y₀, and z₀ are calculated respectively from Formulas (13) to (15). The processing device 150 calculates the coordinate set P₀(x₀, y₀, z₀) of the circumcenter O as the coordinates of the point of action of the tool 20.

The processing device 150 may extract multiple combinations of three coordinate sets. The processing device 150 calculates the coordinates of the circumcenter for each combination. The processing device 150 calculates the median value, average value, or mode of the multiple coordinate sets as the coordinates of the point of action of the tool 20. The accuracy of the calculated point of action can be increased thereby.

Before performing one of the first to third methods, some coordinate sets may be selected from the multiple coordinate sets of the hand. One of the first to third methods is performed using the selected coordinate sets. For example, only the coordinate sets when the hand is estimated to be moving in an arc-like shape are selected, and the coordinate sets to be used in the first to third methods are extracted from these coordinate sets. By using only the coordinate sets when the hand is moving in the arc-like shape, the accuracy of the point of action can be further increased.

As an example, when a digital tool is used, the processing device 150 selects the coordinates of the hand obtained at the timing (the times) at which data is received from the digital tool. When a screw is turned with the digital tool, the torque is measured by the digital tool. The processing device 150 receives the measurement result from the digital tool via the processing device 30. The reception of the measurement result indicates that the hand is moving in an arc-like shape. Therefore, the coordinates of the hand obtained at the timing (the times) at which the measurement result is received are selected and used to calculate the point of action, and so the point of action can be calculated with higher accuracy.

Even when the coordinate sets are not selected, the point of action can be calculated by calculating multiple candidates of the point of action in one of the first to third methods. For example, the processing device 150 excludes outliers from the multiple candidates and calculates the median value, average value, or mode of the remaining candidates as the point of action.

When the point of action has been calculated by one of the methods, the processing device 150 calculates the distance between the coordinates of the hand and the coordinates of the point of action at any timing. The processing device 150 calculates the difference between the calculated distance and the preregistered length of the tool 20. When the difference is less than a preset threshold, the processing device 150 determines that the coordinates of the hand are measured with high accuracy by the hand tracking.

### Other Display Examples

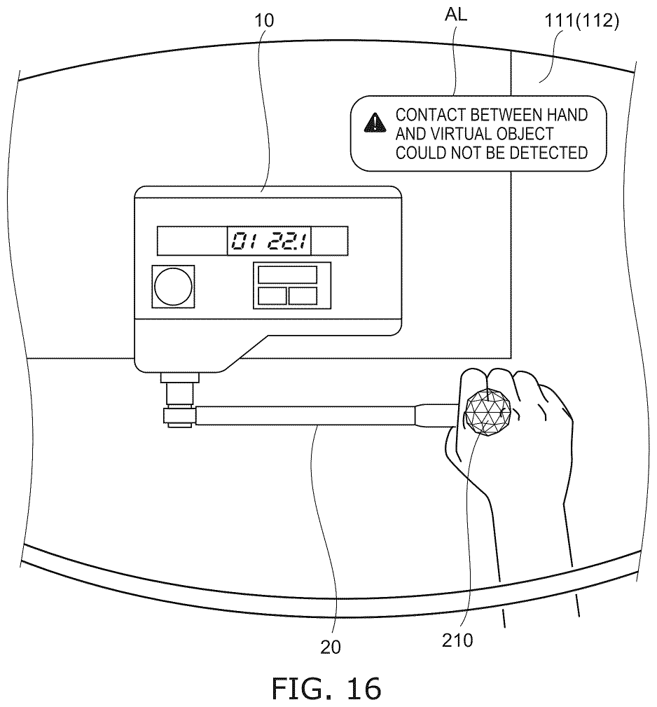

FIG. 16 is a schematic view showing a display example of the mixed reality device according to the embodiment.

When it is determined in the first or second determination that an abnormality is present in the hand tracking, it is favorable to output the determination result to the worker.

For example, when it is determined in the first determination that the hand is not detected, the processing device 150 displays an alert AL as shown in FIG. 16. The alert AL indicates that the hand is not detected by the hand tracking. Similarly, when it is determined in the second determination that the accuracy of the hand tracking is low, the processing device 150 displays an alert of the accuracy. The determination result may be output as a voice instead of a display.

For example, when it is determined in the first determination that the hand is not detected, the worker may restart the MR device 100 or replace the MR device 100. When it is determined in the second determination that the accuracy of the hand tracking is not good, the worker may orient the palm of the hand toward the image camera 131 and the depth camera 132 or restart the MR device 100. The marker 200 may be reimaged, and the three-dimensional coordinate system may be reset. The first determination and the second determination are re-performed after taking action.

### Master Data and Check Results

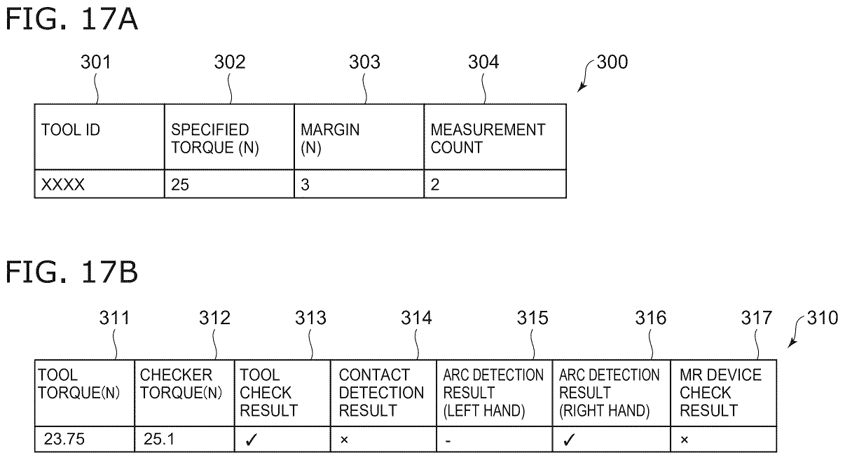

FIG. 17A is a table illustrating master data used in the determination. FIG. 17B is a table illustrating check results.

For example, the master data 300 shown in FIG. 17A is preregistered. The master data 300 includes a tool ID 301, a specified torque 302, a margin 303, and a measurement count 304. The tool ID 301 is a unique identification number assigned to each tool. The specified torque 302 is the torque specified for the tool 20. The margin 303 is the acceptable error of the specified torque 302. The measurement count 304 is the number of times that the torque is measured when checking the tool 20.

The master data 300 is referenced when performing the third determination. The processing device 30 performs the third determination while referring to the master data 300. The MR device 100 performs the first determination and the second determination. As a result, a check result 310 shown in FIG. 17B is generated.

The check result 310 includes a tool torque 311, a checker torque 312, and check results 313 to 317. The tool torque 311 is the torque measured by the tool 20. The checker torque 312 is the torque measured by the torque checker 10. The check result 313 indicates the result of the third determination. The check result 314 indicates whether or not the contact between the hand and the virtual object is detected, and corresponds to the result of the first determination. The check result 315 indicates the result of the second determination based on the movement of the left hand. The check result 316 indicates the result of the second determination based on the movement of the right hand. The check result 317 indicates the result of the overall check of the MR device 100. In the check results 313 to 317, a passing result is illustrated by a check mark. A failing result is illustrated by a cloth. Items for which the determination could not be performed are marked with hyphens. For example, when one of the check results 314 to 316 fails, it is indicated in the check result 317 that the MR device 100 failed the check. When all of the check results 314 to 316 pass, it is indicated in the check result 317 that the MR device 100 passed the check.

### Checking Task

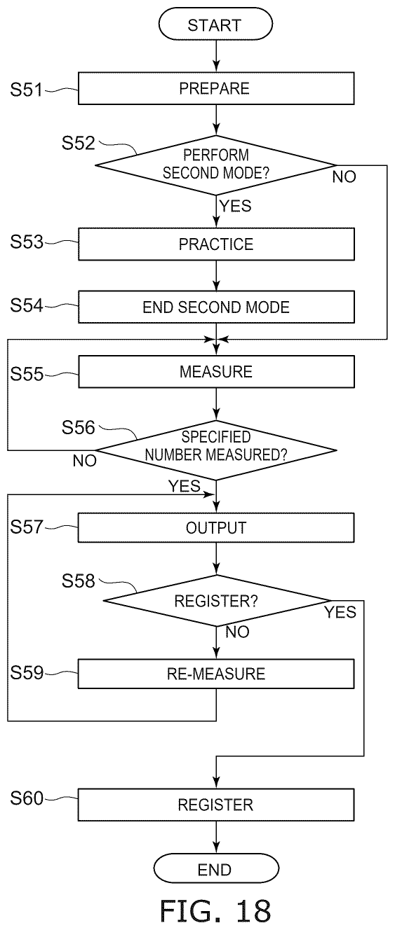

FIG. 18 is a flowchart showing the flow of a checking task.

The overall flow of a checking task using the determination method according to the embodiment will now be described with reference to FIG. 18. First, the worker prepares the torque checker 10, the tool 20, the processing device 30, and the MR device 40 (step S51). The processing device 30 is set to be able to communicate with the torque checker 10 and the MR device 40. When the tool 20 is a digital tool, the tool 20 also is set to be able to communicate with the processing device 30. The worker wears the MR device 40 and places the torque checker 10 at a prescribed position.

The worker selects whether or not to perform the second mode (step S52). For example, the worker inputs, by voice, to the MR device 40 whether or not to perform the second mode. A virtual icon for selecting whether or not to perform the second mode may be displayed, and the worker may touch the icon.

When the second mode is performed, the worker prepares or practices the checking task in the second mode (step S53). In the second mode, a check is not performed even when the worker applies torque to the torque checker 10 with the tool 20. More specifically, even when the torque checker 10 measures the torque and the processing device 30 receives the measurement result in the second mode, the processing device 30 does not perform the first determination or second determination.

When the preparation or the practice is finished, the worker ends the second mode (step S54). The processing device 30 transitions to the first mode in which the first determination and the second determination are performed.

The worker applies a torque to the torque checker 10 with the tool 20; and the torque checker 10 measures the torque (step S55). At this time, the processing device 30 and the MR device 40 perform various determinations. For example, the first determination is performed based on the result of the contact determination between the hand and the virtual object and the measurement result from the torque checker 10 or the tool 20. The second determination is performed based on the measurement result of the coordinates of the hand. The third determination is performed based on the measurement result from the torque checker 10. The fourth determination also may be performed based on the measurement result from the tool 20.

The processing device 30 determines whether or not the specified number of measurements has been performed by the torque checker 10 (step S56). When the number of measurements performed is less than the specified number, step S55 is re-performed.

The MR device 40 outputs the results of the various determinations to the worker (step S57). The worker checks the determination results and selects whether or not the determination results should be registered in the database (step S58).

When the determination results are not registered, the worker re-measures the torque with the torque checker 10 (step S59). For example, if a result indicating an abnormality of the hand tracking or the tool 20 is obtained in any of the measurements, the measurement can be re-performed. Step S57 is then re-performed, and the determination result of the re-measure is output.

When it is selected to register the determination result in step S58, the processing device 30 registers the check result shown in FIG. 17B in the database (step S60).

According to the determination method according to the embodiment, it can be checked whether or not the tool 20 and the MR device 40 are normal. After the check, the task is performed using the tool 20 and the MR device 40. An example of a task using the tool 20 and the MR device 40 will now be described.

### Task Example

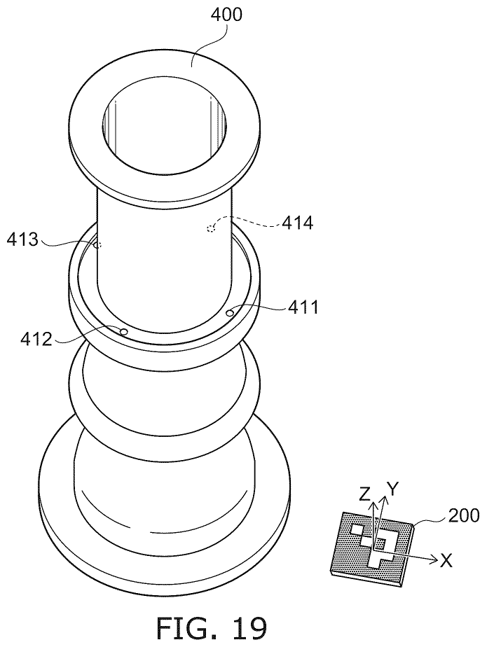

FIG. 19 is a schematic view illustrating an article that is a task object.

For example, a fastening task is performed on the article 400 shown in FIG. 19. The article 400 is a tubular hollow member, and includes fastening locations 411 to 414. The worker uses the tool 20 to tighten screws respectively at the fastening locations 411 to 414.

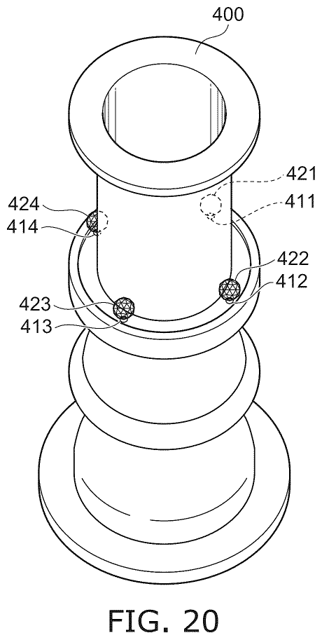

FIGS. 20 to 22 are schematic views for describing display examples of the processing system according to the embodiment.

When the fastening task is started, the image camera 131 and the depth camera 132 image the marker 200. The processing device 150 recognizes the marker 200 based on the captured image. The processing device 150 sets a three-dimensional coordinate system referenced to the position and orientation of the marker 200. When the three-dimensional coordinate system set for the task and the three-dimensional coordinate system set for the check are a common three-dimensional coordinate system, the virtual space may be displayed based on the three-dimensional coordinate system set for the task. In such a case, the recognition of the marker 200 and the setting of the three-dimensional coordinate system may be omitted.

As shown in FIG. 20, the processing device 150 displays virtual objects 421 to 424 corresponding to the fastening locations 411 to 414. The virtual objects 421 to 424 are respectively adjacent to the fastening locations 411 to 414. The virtual objects 421 to 424 respectively indicate the positions at which the hand of the worker should be located when tightening at the fastening locations 411 to 414. The positions at which the virtual objects 421 to 424 are displayed are preregistered using a three-dimensional coordinate system based on the origin of the marker 200.

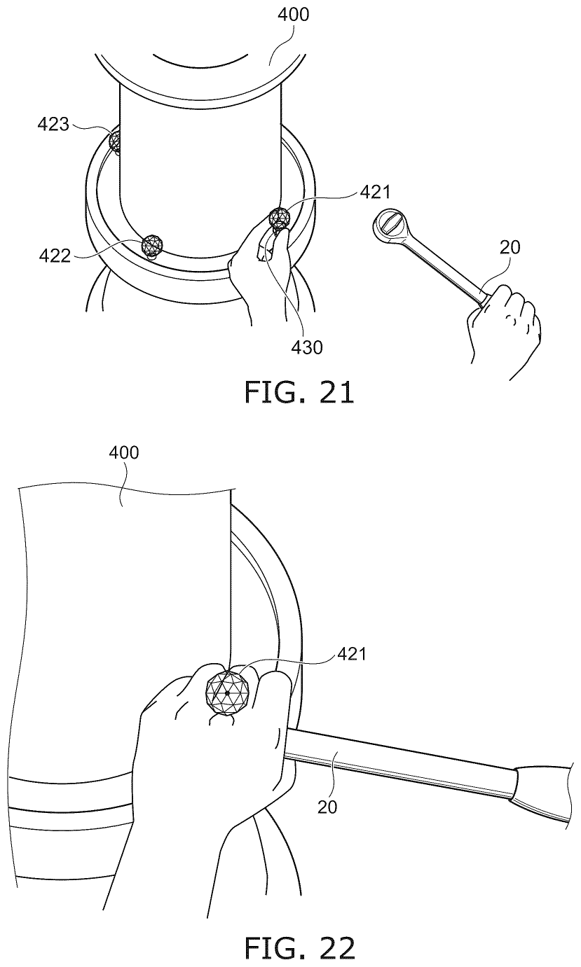

As an example, the worker tightens a screw at the fastening location 411. In such a case, as shown in FIG. 21, the worker places a screw 430 at the threaded hole of the fastening location 411. The worker then holds the grip of the tool 20 with the right hand. The worker fits, onto the screw 430, the tip (the head) of the tool 20 to which a socket is mounted. Then, as shown in FIG. 22, the worker rotates the tool 20 with the right hand while pressing the head of the tool 20 with the left hand. The screw 430 is tightened thereby.

In the series of operations described above, the processing device 150 determines whether or not the hand contacts any of the virtual objects. In the illustrated example, the left hand that presses the tip of the tool 20 when tightening the screw 430 contacts the virtual object 421. When the hand contacts the virtual object, it can be estimated that the screw is being turned at the fastening location corresponding to the virtual object. Herein, the fastening location that corresponds to the virtual object contacted by the hand and is estimated to be where the screw is being turned is referred to as the “estimated location”.

The processing device 150 generates a task record when it is estimated that a screw is being turned at a specific fastening location. For example, the processing device 150 associates data indicating that the screw was turned with data related to the fastening location 411, and stores the data. When the tool 20 is a digital tool, the torque, measurement count, and the like measured by the tool 20 also may be associated.

By displaying the virtual objects, the worker can easily ascertain the task to be performed and the location at which the task is to be performed. When the fastening sequence of the fastening locations 411 to 414 is specified, only one of the virtual objects 421 to 424 may be displayed according to the sequence.

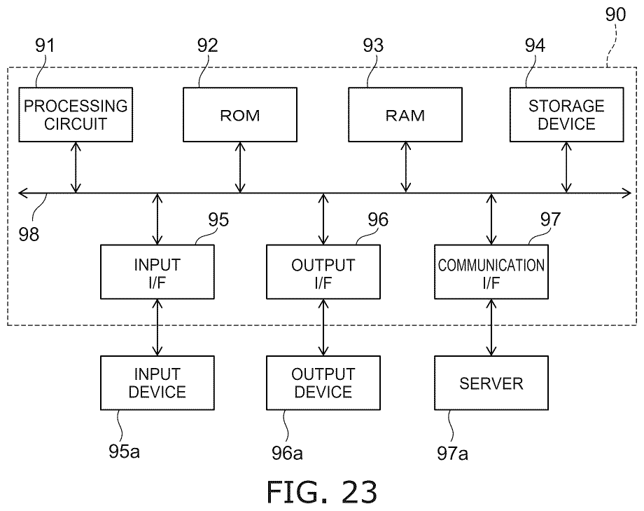

FIG. 23 is a schematic view illustrating a hardware configuration.

The torque checker 10, the processing device 30, and the MR device 40 include, for example, the configuration of a computer 90 shown in FIG. 23 to process various data. The computer 90 performs the various processing described above. The computer 90 includes a processing circuit 91, ROM 92, RAM 93, a storage device 94, an input interface 95, an output interface 96, and a communication interface 97.

The ROM 92 stores programs controlling operations of the computer 90. The ROM 92 stores programs necessary for causing the computer 90 to realize the processing described above. The RAM 93 functions as a memory region into which the programs stored in the ROM 92 are loaded.

The processing circuit 91 includes an arithmetic processor such as a CPU, a GPU, etc. The processing circuit 91 uses the RAM 93 as work memory to execute the programs stored in at least one of the ROM 92 or the storage device 94. When executing the programs, the processing circuit 91 executes various processing by controlling configurations via a system bus 98.

The storage device 94 stores data necessary for executing the programs and/or data obtained by executing the programs.

The input interface (I/F) 95 can connect the computer 90 and an input device 95a. The input I/F 95 is, for example, a serial bus interface such as USB, etc. The processing circuit 91 can read various data from the input device 95a via the input I/F 95.

The output interface (I/F) 96 can connect the computer 90 and an output device 96a. The output I/F 96 is, for example, an image output interface such as Digital Visual Interface (DVI), High-Definition Multimedia Interface (HDMI (registered trademark)), etc. The processing circuit 91 can transmit data to the output device 96a via the output I/F 96 and cause the output device 96a to display an image.

The communication interface (I/F) 97 can connect the computer 90 and a server 97a outside the computer 90. The communication I/F 97 is, for example, a network card such as a LAN card, etc. The processing circuit 91 can read various data from the server 97a via the communication I/F 97.

The storage device 94 includes at least one selected from a hard disk drive (HDD) and a solid state drive (SSD). The input device 95a includes at least one selected from a mouse, a keyboard, a microphone (audio input), and a touchpad. The output device 96a includes at least one selected from a monitor, a projector, a printer, and a speaker. A device such as a touch panel that functions as both the input device 95a and the output device 96a may be used.

The processing that is performed by the processing device 30 or the MR device 40 may be performed by one computer 90 or by collaboration of multiple computers 90. In the examples described above, the first determination and the second determination are performed by a computer (the processing device 150) of the MR device 40; and the third determination and the fourth determination are performed by a computer of the processing device 30. The configuration is not limited to the examples; any one or more selected from the first to fourth determinations may be performed by a computer of the processing device 30; and the other determinations may be performed by a computer of the MR device 40. All of the first to fourth determinations may be performed by a computer of the processing device 30 or a computer of the MR device 40.

The processing of the various data described above may be recorded, as a program that can be executed by a computer, in a magnetic disk (a flexible disk, a hard disk, etc.), an optical disk (CD-ROM, CD-R, CD-RW, DVD-ROM, DVD+R, DVD+RW, etc.), semiconductor memory, or another non-transitory computer-readable storage medium.

For example, data of a recording medium is read by a computer (or an embedded system). The recording format (the storage format) of the recording medium is arbitrary. For example, the computer reads a program from the recording medium and causes a CPU to execute instructions based on the program. The acquisition (or the reading) of the program by the computer may be performed via a network.

The embodiments of the invention include the following features.

### Feature 1

A determination method, including:
causing a computer to
   acquire a first image of a torque checker when a force is applied to the torque checker by a tool held by a hand,
   perform hand tracking on the first image, and
   perform a first determination of determining whether or not the hand is detected by the hand tracking.

### Feature 2

The determination method according to feature 1, in which
the computer is caused to perform a second determination when the hand is determined to be detected in the first determination, and
in the second determination, the computer is caused to:
   calculate an evaluation value by using coordinates of the hand; and
   determine whether or not an accuracy of the hand tracking is sufficient based on a comparison result between the evaluation value and a reference value, the reference value being preset.

### Feature 3

The determination method according to feature 1 or 2, in which
the computer is caused to:
   receive a first measurement result of a torque applied by the tool as measured by the torque checker; and
   perform the first determination after the first measurement result is received.

### Feature 4

The determination method according to feature 1 or 2, in which
the computer is caused to:
   receive a first measurement result of a torque applied by the tool as measured by the torque checker; and
   perform a third determination of determining whether or not the tool is normal based on the first measurement result.

### Feature 5

The determination method according to feature 4, in which
the tool is configured to measure a torque, and
the computer is caused to:
   receive a second measurement result from the tool; and
   perform a fourth determination of determining, based on the second measurement result, a reliability of a determination result of the third determination.

### Feature 6

The determination method according to any one of features 2 to 5, in which
in the second determination, the computer is caused to compare a length of the tool to the reference value by using the coordinates of the hand to calculate the length of the tool.

### Feature 7

The determination method according to any one of features 2 to 5, in which
in the second determination, the computer is caused to compare, to the reference value, a distance between coordinates of a portion of the tool and preset coordinates by using the coordinates of the hand to calculate the coordinates of the portion of the tool.

### Feature 8

The determination method according to any one of features 1 to 7, in which
the computer is caused to:
   acquire a second image of a marker, the marker being prepared beforehand;
   detect the marker in the second image;
   set a spatial coordinate system by using the marker as an origin; and
   calculate coordinates of the hand in the spatial coordinate system.

### Feature 9

The determination method according to feature 8, in which
the computer is caused to:
   display a virtual object at preset coordinates in the spatial coordinate system; and
   detect a contact between the virtual object and a prescribed object.

### Feature 10

A determination method, including:
causing a computer to
   display a virtual object in a virtual space,
   measure coordinates of a hand by hand tracking,
   perform a first determination of determining whether or not there is contact between the virtual object and the hand by comparing a distance between the virtual object and the coordinates of the hand to a threshold, and
   perform a second determination including
      determining whether or not there is contact between the virtual object and the hand when a first measurement result of a torque applied by a tool is received from a torque checker configured to measure the torque, and
      determining that the hand tracking is abnormal when there is no contact between the virtual object and the hand when the first measurement result is received.

### Feature 11

The determination method according to feature 10, in which
the computer is caused to perform a third determination of determining whether or not the tool is normal based on the first measurement result.

### Feature 12

The determination method according to feature 11, in which
the tool is configured to measure a torque, and
the computer is caused to:
   receive a second measurement result from the tool; and
   perform a fourth determination of determining whether or not a determination result of the third determination is appropriate based on the second measurement result.

### Feature 13

The determination method according to feature 10, in which
the computer is caused to:
   detect a marker in an image, the marker being prepared beforehand;
   set a spatial coordinate system by using the marker as an origin; and
   calculate coordinates of the hand in the spatial coordinate system.

### Feature 14

The determination method according to feature 13, in which
the computer is caused to display the virtual object at preset coordinates in the spatial coordinate system.

### Feature 15

A processing device to perform the determination method according to any one of features 1 to 14.

### Feature 16

A processing system, including:
the processing device according to feature 15; and
a cross reality device configured to calculate the coordinates of the hand by performing the hand tracking.

### Feature 17

A program, when executed by a computer, causing the computer to perform the determination method according to any one of features 1 to 14.

### Feature 18

A storage medium configured to store the program according to feature 17.

According to the embodiments above, a determination method, a processing device, a processing system, program, and a storage medium are provided in which a tool and an MR device can be efficiently checked before a task.

In the specification, “or” shows that “at least one” of items listed in the sentence can be adopted.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention. Moreover, above-mentioned embodiments can be combined mutually and can be carried out.

What is claimed is:

1. A determination method, comprising:
causing a computer to
acquire a first image of a torque checker when a force is applied to the torque checker by a tool held by a hand,
perform hand tracking on the first image, and
perform a first determination of determining whether or not the hand is detected by the hand tracking.

2. The determination method according to claim 1, wherein
the computer is caused to perform a second determination when the hand is determined to be detected in the first determination, and
in the second determination, the computer is caused to:
calculate an evaluation value by using coordinates of the hand; and
determine whether or not an accuracy of the hand tracking is sufficient based on a comparison result between the evaluation value and a reference value, the reference value being preset.

3. The determination method according to claim 1, wherein
the computer is caused to:
receive a first measurement result of a torque applied by the tool as measured by the torque checker; and
perform the first determination after the first measurement result is received.

4. The determination method according to claim 1, wherein
the computer is caused to:
receive a first measurement result of a torque applied by the tool as measured by the torque checker; and
perform a third determination of determining whether or not the tool is normal based on the first measurement result.

5. The determination method according to claim 4, wherein
the tool is configured to measure a torque, and
the computer is caused to:
receive a second measurement result from the tool; and
perform a fourth determination of determining, based on the second measurement result, a reliability of a determination result of the third determination.

6. The determination method according to claim 2, wherein
in the second determination, the computer is caused to compare a length of the tool to the reference value by using the coordinates of the hand to calculate the length of the tool.

7. The determination method according to claim 2, wherein
in the second determination, the computer is caused to compare, to the reference value, a distance between coordinates of a portion of the tool and preset coordinates by using the coordinates of the hand to calculate the coordinates of the portion of the tool.

8. The determination method according to claim 1, wherein
the computer is caused to:
acquire a second image of a marker, the marker being prepared beforehand;
detect the marker in the second image;
set a spatial coordinate system by using the marker as an origin; and
calculate coordinates of the hand in the spatial coordinate system.

9. The determination method according to claim 8, wherein
the computer is caused to:
display a virtual object at preset coordinates in the spatial coordinate system; and
detect a contact between the virtual object and a prescribed object.

10. A processing device configured to perform the determination method according to claim 1.

11. A processing system, comprising:
the processing device according to claim 10; and
a cross reality device configured to calculate coordinates of the hand by performing the hand tracking.

12. A storage medium configured to store a program,
the program, when executed by a computer, causing the computer to perform the determination method according to claim 1.

13. A determination method, comprising:
causing a computer to
display a virtual object in a virtual space,
measure coordinates of a hand by hand tracking,
perform a first determination of determining whether or not there is contact between the virtual object and the hand by comparing a distance between the virtual object and the coordinates of the hand to a threshold, and
perform a second determination including
determining whether or not there is contact between the virtual object and the hand when a first measurement result of a torque applied by a tool is received from a torque checker configured to measure the torque, and
determining that the hand tracking is abnormal when there is no contact between the virtual object and the hand when the first measurement result is received.

14. The determination method according to claim 13, wherein
the computer is caused to perform a third determination of determining whether or not the tool is normal based on the first measurement result.

15. The determination method according to claim 14, wherein
the tool is configured to measure a torque, and
the computer is caused to:
receive a second measurement result from the tool; and
perform a fourth determination of determining whether or not a determination result of the third determination is appropriate based on the second measurement result.

16. The determination method according to claim 13, wherein
the computer is caused to:
detect a marker in an image, the marker being prepared beforehand;
set a spatial coordinate system by using the marker as an origin; and
calculate coordinates of the hand in the spatial coordinate system.

17. The determination method according to claim 16, wherein
the computer is caused to display the virtual object at preset coordinates in the spatial coordinate system.

18. A processing device configured to perform the determination method according to claim 13.

19. A processing system, comprising:
the processing device according to claim 18; and
a cross reality device configured to calculate the coordinates of the hand by performing the hand tracking.

20. A storage medium configured to store a program,
the program, when executed by a computer, causing the computer to perform the determination method according to claim 13.
